(19) United States
(12) Patent Application Publication
(10) Pub. No.: US 2006/0034485 A1
(43) Pub. Date: Feb. 16, 2006

(54) Point location in multi-modality stereo imaging

(76) Inventor: Shahriar Negahdaripour, Coral Gables, FL (US)

Correspondence Address: EDWARDS & ANGELL, LLP, P.O. BOX 55874, BOSTON, MA, 02205, US

(21) Appl. No.: 11/201,456

(22) Filed: Aug. 11, 2005

Related U.S. Application Data
(60) Provisional application No. 60/601,520, filed on Aug. 12, 2004.

(51) Int. Cl. G06K 9/00

(52) U.S. Cl. 382/103

(57) ABSTRACT

A multimodal point location method can include the steps of acquiring at least two different images of a target object with cameras of different imaging modalities, including acoustic and optical cameras, and matching point coordinates in each of the two different images to reconstruct a point in a three-dimensional reconstructed view of the target object. In this regard, the images can include two-dimensional images. In a preferred aspect of the invention, the matching step can include the steps of computing a rotation matrix and a translation vector for the images and further computing a conical or trigonometric constraint for the images.

### CROSS-REFERENCE TO RELATED APPLICATIONS

This application is a Non-Provisional Application of Provisional (35 U.S.C. § 119(e)), Application No. 60/601,520, filed on Aug. 12, 2004.

### BACKGROUND OF THE INVENTION

The present invention relates to stereo imaging and more particularly to target point localization with a stereo imaging system.

Stereo imaging relates to the reconciliation of multiple two-dimensional images of a three-dimensional target object into a three-dimensional reconstruction of the object. Artificial stereo imaging, as in the case of natural stereo imaging of the human pair of eyes, involves the recording of images of a visually perceptible scene from two (or more) positions in three-dimensional space. Typically, artificial stereo imaging involves two or more cameras of the same imaging modality, for example video or acoustic ranging cameras. In this regard, the camera can produce the same type of image merely from different positions in the viewing space. The differences in the images as perceived from the different cameras, then, is primarily due to the view of the target image from different positions in space.

In stereo imaging, stereo disparity represents the visual cue for depth perception. Stereo disparity specifically refers to the difference in the image positions in two views of the same feature in a visually perceptible space. In this regard, the more distant a scene feature appears, the smaller is the disparity between the views. The opposite can be stated for a feature less distant in the visually perceptible space. In stereo vision, the primary complexity in determining the depth of a point in space is to determine which feature in one view corresponds to a feature apparent in the other view. This well-known complexity often is referred to as the “correspondence problem”.

Though it may seem otherwise, the skilled artisan will recognize that the matching of a point in one view from one camera position with a corresponding point in another view from another camera position involves not a two-dimensional search, but a mere one-dimensional search. This is so because the relative position of the cameras typically is known, for example through an a priori calibration process. Consequently, the point in the companion image will be constrained to lie on a particular line. Accordingly, in practice, certain properties of the point, for example the intensity of the point, can be matched to one another along the constraint line. In the art, this constraint on the location of the matching features (also known as conjugate pairs) is referred to as the “epipolar constraint”.

Much of the art of locating matching points across different acquired views of the same scene point is known in respect to cameras of identical modality—specifically, optical imaging video cameras. In this regard, the specific problem of locating matching points acquired through the lenses of two different optical cameras remains a one-dimensional problem of constraining the point along straight (epipolar) lines, which follows from the projection geometry for optical cameras according to the ideal pin-hole camera model (referred to herein as pin-hole camera projection geometry). In many practical applications, however, it is not always ideal to utilize optical video cameras of identical modality. Rather, in some applications, it is more suitable to utilize cameras of different modalities, such as acoustic cameras and the like.

As an example of a multi-modality circumstance, both optical and acoustic cameras are suitable imaging systems to inspect underwater structures, both in the course of performing regular maintenance and also in the course of policing the security of an underwater location. In underwater applications, despite the availability of high resolution video imaging, optical systems enjoy mere limited visibility range when deployed in turbid waters. By comparison, the latest generation of high-frequency acoustic cameras can provide images with enhanced target details even in highly turbid waters, despite the reduction in range by one to two orders of magnitude compared to traditional low to mid frequency sonar systems.

Accordingly, it would be desirable to deploy both optical and acoustic cameras on a submersible platform to enable the high-resolution target imaging in a range of turbidty conditions. In this scenario, images from both optical and acoustic cameras can be registered to provide more valuable scene information that cannot be readily recovered from each camera alone. Still, in the multi-modality circumstance, point correlation based upon the reconciliation of imagery acquired from cameras of disparate modality cannot be reliably determined through conventional methodologies.

### BRIEF SUMMARY OF THE INVENTION

The present invention advantageously provides a point location system and method which overcomes the point location difficulties utilizing images from disparate camera types of the prior art and provides a novel and non-obvious point correlation system, method and apparatus which facilitates the location of points across different views of the same scene target from disparate camera modalities. In a preferred aspect of the invention, video and sonar cameras can be placed in a binocular stereo configuration. Two-dimensional images of a target object acquired through the cameras can be processed to determine a three dimensional reconstruction of the target object. In particular, points in the three-dimensional image can be computed based upon triangulation principles and the computation of conical and trigonometric constraints in lieu of traditional epipolar lines in single-modality stereovision systems.

A multimodal point location system can include a data acquisition and reduction processor disposed in a computing device and at least two cameras, one of which is not an optical video camera, and possibly both of which are of different modalities coupled to the computing device. The system also can include a point reconstruction processor configured to process image data received through the computing device from the cameras to locate a point in a three-dimensional view of a target object. In a preferred aspect of the invention, the cameras can include at least one sonar sensor and one optical sensor. Moreover, the point reconstruction processor can include logic for computing homogeneous quadratic constraints (conics) or trigonometric functions for matching coordinate points in image data from different ones of the cameras.

A multimodal point location method can include the steps of acquiring at least two different images of a target object from corresponding cameras of different modalities and matching point coordinates in each of the two different images to determine the point on a three-dimensional reconstruction of the target object. In this regard, the images can include two-dimensional images. In a preferred aspect of the invention, the matching step can include the steps of computing a rotation matrix and a translation vector for the relative positions of the two cameras and further computing conical or trigonometric constraints for the matching points (conjugate pairs) in the images.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a schematic illustration of a multi-modality stereo-imaging system configured for point location in accordance with a preferred aspect of the present invention; and,

FIG. 2 is a flow chart illustrating a process for point location in the multi-modality stereo-imaging system of FIG. 1.

### DETAILED DESCRIPTION OF THE INVENTION

The present invention is a method, system and apparatus for determining points on a three-dimensional reconstruction of the target object in a multi-modality stereo-imaging system. In accordance with the inventive arrangements, two or more cameras of different image acquisition and processing modalities can be placed to acquire different two-dimensional image views of a target object. Two-dimensional projections of selected target points can be matched to locate these object points in a three-dimensional reconstruction of the target object. Specifically, in the case of sonar and video camera placements, a rotation matrix and a translation vector can be computed from selected matching image points. Additionally, a conical or trigonometric constraint is computed from the rotation matrix and translation vector to constrain the search space of each matching point. Finally, the matching points are used to locate the point in the three-dimensional reconstruction of the object points by triangulation.

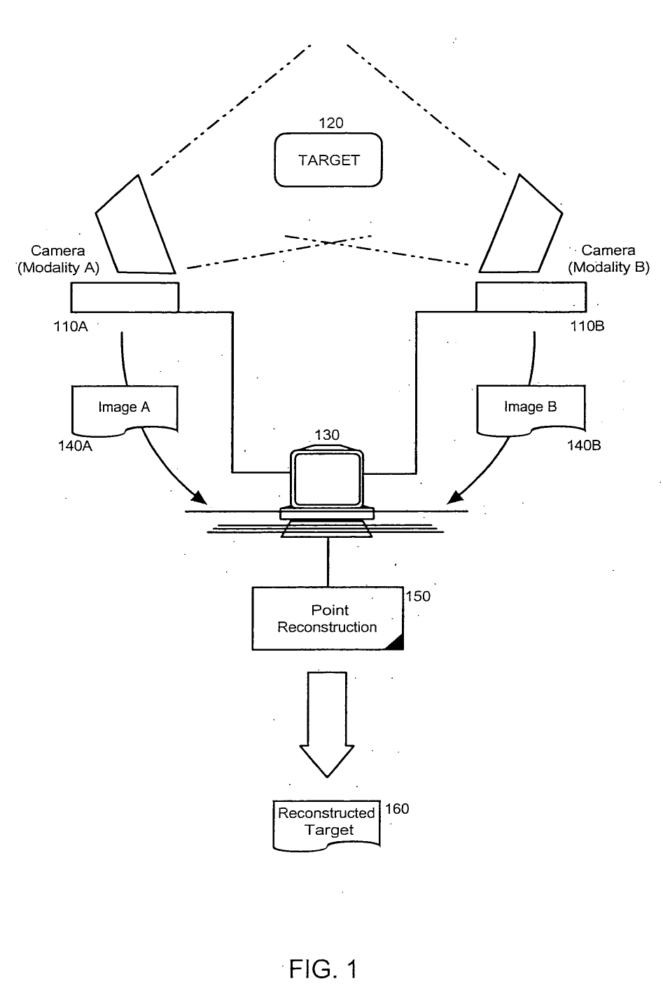

In more particular illustration of a preferred embodiment of the inventive arrangements, FIG. 1 is a schematic illustration of a multi-modality stereo-imaging system configured for determining a point on a three-dimensional reconstruction of the target object. The stereo imaging system can include two or more cameras 110A, 110B of different image acquisition and processing modalities. For instance, the cameras 110A, 110B can include, by way of non-limiting example, video cameras, infrared sensing cameras, sonar cameras, to name a few. Each of the cameras 110A, 110B can be focused upon a target object 120 so as to individually acquire different two-dimensional (2-D) image views 140A, 140B of the target object 120. To process the different image views 140A, 140B, each of the cameras 110A, 110B can be communicatively coupled to a computing device 130 configured with a point reconstruction processor 130. The point reconstruction processor 130, in turn, can be programmed to produce a three-dimensional (3-D) reconstruction of each target point 150, and finally 3-D reconstructed target 160 by locating different matching points in the image views 140A, 140B.

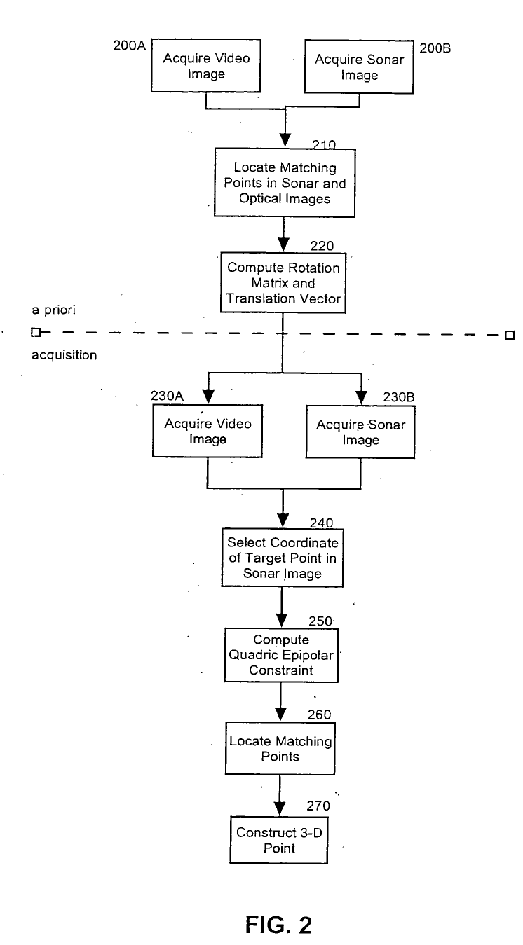

Specifically, the reconstructed target 160 of FIG. 1 can be produced within the point reconstruction processor 130 based upon the different image views 140A, 140B so as to locate points in the image views 140A, 140B at a proper depth in the reconstructed 3-D view of the target object 120. In this regard, FIG. 2 illustrates an a priori process for calibrating the system of FIG. 1 and for locating a point in the multi-modality stereo-imaging system of FIG. 1. Beginning in block 210, an a priori process of computing a rotation matrix and translation vector can be undertaken.

Notably, as the process described herein can be a piori in nature, in blocks 200A and 200B, sonar and video coordinates of a certain number of features can be determined for a known target. In block 210, the user may specify what point in the video image corresponds to which point in the sonar image. That is, the matching of corresponding points may be done manually for simplicity, though there is no reason it can not be done automatically through some robust estimation algorithms. At this point, the matching can be performed based upon a two-dimensional search if done automatically since the relative geometry of the two cameras will not have yet been known. Finally, in block 220 R and t can be determined which define the relative rotation (R) and translation (t) between the coordinate systems of the sonar and video cameras.

During an operation is where the matching has to be done automatically. Since sonar and video cameras (are assumed to) remain fixed in the same configuration as during calibration, the same R and t apply, and thus need not be determined again. These R and t values define the non-pin-hole epipolar geometry for the multimodal system of the present invention. In the case where the geometry of the two cameras is changed, it is possible, though requiring more computations, to determine both R and t, as well as to reconstruct the 3-D points on the target object. Returning now to FIG. 2, in blocks 230A and 230B, multimodal imagery can be acquired, for example through video and sonar means. In particular, where one of the image views is optically acquired, the 2-D optical image lo(x,y) encodes information about the radiance of the scene surfaces.

By comparison, acoustically acquired form of the image views (e.g., a forward-scan (FS) sonar image) can be described as a 2-D array of acoustic reflectances from scene surface patches. The intensity of each image point is proportional to the sound reflection from a particular azimuth direction at an instant of time. The latter is transformed to range measurements as distance traveled by an acoustic wave is proportional to time. Thus, the intensity of an acoustic image la(Θ, R) encodes information about the strength of the sonar return in a particular azimuth direction Θ from surfaces at a specific range R from the receiver. It may be apparent to a person skilled in the art that an acoustic image la(Θ, R) may be transformed to other representations of the form la(ρ,ξ) by proper coordinate transformation, including but not limited to ρ=R cos Θ and ξ=R sin Θ. More generally, ρ=ρ(R,Θ) and ξ=(R, Θ) represent other suitable coordinate transformation functions, and most computations and derivations that are described here can be readily done in this new coordinate space.

Returning now to FIG. 2, in block 240, specified coordinates within the acquired sonar image la(Θ, R) are located. As such, for every point in the sonar camera image la(Θ, R), the corresponding point in the optical image is constrained to remain on a conic (rather than a straight line as would have been the case with two optical cameras). Thus, the search for the match is a one-dimensional problem along a conic and thus can be done more readily with some automated algorithm. It is apparent that if any other image representation by coordinate transformation of the sonar image is used, including but not limited to ρ=R cos Θ and ξ=R sin Θ, then the equation of the conic needs to be revised to reflect such a coordinate transformation. The same goes with the optical image, where a suitable transformation from traditional ^{(x, y)} coordinates to new coordinates ^{(x′, y′)} may be applied. Since there can be many such transformations, and therefore the conic equation needs to be adjusted accordingly to account for any one of these transformations, all of which cannot be covered in this document, we assume the sonar image representation la(Θ, R) and the optical image representation lo(x,y).

Similarly, in block 240, the process may start with locating specified coordinates within the acquired optical image. As such, for every point in the optical camera image, the corresponding point in the sonar image is constrained to remain on a trigonometric curve. Thus, the search for the match is again a one-dimensional problem along a trigonometric curve and thus can be done more readily with some automated algorithm. As in the above paragraph, the trigonometric curve may change as a function of transformation from traditional (x,y) coordinates to new coordinates^{(x′,y′)} or from (R, Θ) to (ρ,ξ).

A pin-hole camera model can be applied to represent the projection for most optical cameras. The relationship between the pixel coordinate [x,y] and the corresponding scene point [X, Y, Z] is governed by the perspective projection geometry, Specifically, the projection of a target point R with coordinates [X,Y,Z]is given by

$$x = f ( \frac{X}{Z} ) and y = f ( \frac{Y}{Z} ) ,$$

where ƒ is the effective focal length of the optical camera. Just as the coordinates of a target point R can be expressed using rectangular coordinates [X,Y,Z], the target point R can be expressed using spherical coordinates [θ,φ,R], where θ and φ are the azimuth and depression angles, respectively, of a particular direction, and R is the range. Notably, θ is measured clockwise from y-axis and the two coordinates can be related by

$$[ \begin{matrix}X \\ Y \\ Z\end{matrix} ] = R [ \begin{matrix}cos ϕ sin θ \\ cos ϕ cos θ \\ sin ϕ\end{matrix} ]$$

where the inverse transformation is given by

$$θ = {tan}^{- 1} ( \frac{X}{Y} ) , ϕ = {tan}^{- 1} ( \frac{Z}{\sqrt{{X}^{2} + {Y}^{2}}} ) , and R = \sqrt{{X}^{2} + {Y}^{2} + {Z}^{2}} .$$

Just as in stereo imaging with video cameras, triangulation with matching views in the video and sonar cameras enables the reconstruction of the corresponding 3-D target point P. Mathematically, the problem is solved as follows. Consider the video coordinates

$$p = [ x , y , f ] , where x = f ( \frac{{X}_{l}}{{Z}_{l}} ) and y = f ( \frac{{Y}_{l}}{{Z}_{l}} ) , \\ and {P}_{l} = [ {X}_{l} , {Y}_{l} , {Z}_{l} ]$$

is the coordinate of some point P in the camera coordinate system. Without loss of generality, focal length ƒ can be chosen as unit of length so we can set ƒ=1. Correspondingly, the match s=[θ,R] in the sonar image have the azimuth-range coordinates

$$θ = {tan}^{- 1} ( \frac{{X}_{r}}{{Y}_{r}} ) and R = \sqrt{{X}_{r}^{2} + {Y}_{r}^{2} + {Z}_{r}^{2}} , where {P}_{r} = {[ {X}_{r} , {Y}_{r} , {Z}_{r} ]}^{T}$$

is the coordinate of P in the sonar coordinate system.

The coordinates Pₗ and Pᵣ are related by Pᵣ=ΩPₗ+t where Ω is a 3×3 rotation matrix and displacement t=[tₓ,t_{y}t_{z}]^{T} is the stereo baseline vector, collectively defining the rigid body transformation between the coordinate frames of the two imaging systems. In blocks 230 and 240 of FIG. 2, R and t can be determined from the a priori image measurements of known targets as described previously.

The range of a 3-D target point can be expressed in terms of the rotation matrix translation vector, and the 3-D coordinates in the two camera systems by the equation, R=|Pᵣ|=|ΩPₗ+t|=\sqrt{|Pₗ|²+2t^{T}ΩPₗ+|t|²} which can be reduced to |Pₗ|²+2(t^{T}Ω)Pₗ+(|t|²−R²)=0. Applying the video image coordinates to the reduction yields (|p|²)Z₁²+2(t^{T}Ωp)Z₁+(|t|²−R²)=0. Solving for Zₗ results in two solutions. Given that the target range is typically much larger that the stereo baseline so that (|t|²−R²)<0, the two roots of the solution will enjoy opposing signs. The correct solution Zₗ>0 can be readily identified. To locate the point in the 3-D reconstruction from a point in the camera coordinate system, one need only apply the equation Pₗ=Zₗp.

The foregoing 3-D reconstruction presupposes the matching of the video points with the sonar points. In practice, however, the matching of the points to one another can be complex and, in a unimodal system of cameras, can be determined along relational epipolar lines as is well known in the art. The same is not true, however, when considering the multimodal system of the present invention. Rather, in block 250, the epipolar constraint can be determined beginning first with the sonar coordinates s=[θ,R] of point P, to write

$$tan θ = ( \frac{{X}_{r}}{{Y}_{r}} ) and {R}^{2} = {X}_{r}^{2} + {Y}_{r}^{2} + {Z}_{r}^{2} .$$

With rᵢ(i=1,2,3) denoting rows of the rotation metrix Ω written in column vector form, the following equation can be expressed: Xᵣ=r₁·Pₗ+tₓ and Yᵣ=r₂·Pₗ+t_{y} which can be substituted into the sonar azimuth equation as follows:

$$tan θ = ( \frac{{r}_{1} \cdot {P}_{l} + {t}_{x}}{{r}_{2} \cdot {P}_{l} + {t}_{y}} )$$

thereby producing the constraint equation (r₁−tan θr₂)·Pₗ+(tₓ−tan θt_{y})=0. Applying the video coordinate systems to produce Zₗ(r₁−tan θr₂)·p+(tₓ−tan θt_{y})=0, the depth coordinate can be computed utilizing the following equation:

$${Z}_{l} = \frac{( tan θ {t}_{y} - {t}_{x} )}{( {r}_{1} - tan θ {r}_{2} ) \cdot p} .$$

Recalling the equation R²=|Pᵣ|²=|ΩPₗ+t|²=|Pₗ|²+2t^{T}ΩPₗ+|t|², another constraint equation can be derived as follows: |Pₗ|²+2(t^{T}Ω)Pₗ+|t|²−R²=0. Again, applying the video coordinate systems produces

$${( p \cdot p )}^{2} + \frac{2}{{Z}_{l}} ( {t}^{T} Ω ) p + \frac{1}{{Z}_{l}^{2}} ( {\vert t \vert}^{2} - {R}^{2} ) = 0.$$

Substituting for Zₗ from earlier expression, the following equation can result:

$${( p \cdot p )}^{2} + 2 ( \frac{( {r}_{1} - tan θ {r}_{2} ) \cdot p}{( tan θ {t}_{y} - {t}_{x} )} ) ( {t}^{T} Ω ) p + {( \frac{{r}_{1} - tan θ {r}_{2} \cdot p}{( tan θ {t}_{y} - {t}_{x} )} )}^{2} ( {\vert t \vert}^{2} - {R}^{2} ) = 0.$$

Further rearranging terms produces p^{T}└(|t|²−R²)(r₁−tan θr₂)(r₁−tan θr₂)^{T}2(tan θt_{y}−tₓ)r₁−tan θr₂)t^{T}Ω)+tan θt_{y}−tₓ)²I┘p=0. This scalar equation, when added to its transpose produces the final constraint p^{T}Qp=0 where

$$Q = \frac{{( tan θ {t}_{y} - {t}_{x} )}^{2}}{{\vert t \vert}^{2} - {R}^{2}} I + ( {r}_{1} - tan θ {r}_{2} ) {( {r}_{1} - tan θ {r}_{2} )}^{T} + ( \frac{tan θ {t}_{y} - {t}_{x}}{{\vert t \vert}^{2} - {R}^{2}} ) ( ( {r}_{1} - tan θ {r}_{2} ) ( {t}^{T} Ω ) + ( {Ω}^{T} t ) {( {r}_{1} - tan θ {r}_{2} )}^{T} ) .$$

As it will be apparent to the skilled artisan, the conjugate pairs in the multi-modal stereo imaging system lie not on epipolar lines. But rather, the match p=[x,y,ƒ] of a sonar image point s=[θ,R] lies on a conic defined by the homogeneous quadratic constraint p^{T}Qp=0, where the 3×3 symmetric matrix Q defines the shape of the conic. Accordingly, in block 260 matching points can be located and in block 270, the points can be reconstructed in 3-D space based upon the point coordinates in each of the multimodal views, the computed rotation and translation vectors, and the computed homogeneous quadratic constraints.

In a similar derivation, one can establish where match of an optical image point can be searched in the sonar image. To write the equation of the curve in the sonar image more compactly, we can define the following terms:
uₖ₁=yrₖ₃−rₖ₂,uₖ₂=xrₖ₃−rₖ₁(k=1,2,3),^{σ}^{ᵢ}^{=t}^{ₓ}^{u}^{₁ᵢ}^{+t}^{_{y}}^{u}^{₂ᵢ}^{+t}^{_{z}}^{u}^{₃ᵢ}^{(i=1,2)}
,
where ^{r}^{ᵢⱼ} denotes the element on the i-th row and j-th column of the 3×3 rotation matrix Ω. For every point p=[x,y,ƒ] in the optical image, the corresponding sonar pixel ^{(R,θ)} satisfies the trigonometric equation given by ^{R=\sqrt{N/D}}, where
N=(u₃₁σ₂−u₃₂σ₁)²+((u₁₂σ₁−u₁₁σ₂) sin θ+(u₂₂σ₁−u₂₁σ₂) cos θ)²,
D=((u₃₁u₁₂−u₃₂u₁₁) sin θ+(u₃₁u₂₂−u₃₂u₂₁) cos θ)².

Accordingly again, in block 260 matching points can be located and in block 270, the points can be reconstructed in 3-D space based upon the point coordinates in each of the multimodal views, the computed rotation and translation vectors, and the computed trigonometric constraints.

More generally, the 3-D reconstruction of a 3-D point on the target surface based on the solution for Zₗ can take advantage of all 4 constraint equations that have been given for the projections of the 3-D point onto the sonar and optical images. More precisely, each component of (x,y) and (R,θ) gives one equation in terms of the three unknowns of a 3-D scene point [X,Y,Z]. This redundancy of information provides us with many possible ways to reconstruct the 3-D point by some least-square estimation method.

While the foregoing most clearly addresses the optical-acoustic stereo problem as the main theme, several variations lead to other applications of the described mathematical models, including but not limited to map-based navigation and time-series change detection. Considering as an example the inspection of a particular structure, for instance a ship hull having a pre-existing model/map. Such inspection may be carried out with the inventive acoustic-optical stereo system, or by deploying solely an acoustic camera. In the latter case, the constraints between the image measurements in the acoustic image and the known target model in the form of a 3-D CAD model, 2-D visual map or mosaic, or the likes, can be exploited. Registration of the acoustic image features with the 3-D model features enables self-localization and automatic navigation of the sonar platform, while carrying out the target inspection. In the former case, the stereo imaging system detailed earlier clearly provides additional visual cues and geometric constraints to solve the problem at hand.

Alternatively, assume that a 2-D photo-mosaic has been constructed in some previous operation. In this scenario, self-localization is achieved by a 2-D to 2-D registration of the acoustic image with the optical image. The problem involves determining the position and orientation of the sonar from the matched 2-D featured. The use of a 2-D photo-mosaic, where available, is preferred since an optical image provides more visual details of the target than an acoustic image. In an operator-assisted mission, the human may guide the registration process by providing a rough location of the remotely operated vehicle, while the computer completes the accurate localization. Furthermore, determining the sensor platform location involves the solution of the geometric constraints described herein by utilizing a suitable number of image feature matches. When the mosaic is available in the form of an acoustic image, the disclosed equations can be solved for a pair of acoustic cameras. Though not recited explicitly, these equations consist of the governing equations for the stereo problem with two acoustic cameras, and can be readily solved either for the 3-D target structure or the sensor platform self-localization from the 2-D matches.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed as new and desired to be protected by Letters Patent of the United States is:

1. A multimodal point location system comprising:
a data acquisition and reduction processor disposed in a computing device;
at least two cameras of which at least one of said cameras is not an optical camera, at least one of said cameras being of a different modality than another, and said cameras providing image data to said computing device; and
a point reconstruction processor configured to process image data received through said computing device from said cameras to locate a point in a three-dimensional view of a target object.

2. The system of claim 1, wherein said cameras comprise at least one sonar sensor and one optical sensor.

3. The system of claim 1, wherein said point reconstruction processor comprises logic for computing conical constraints for matching conjugate points in the images of said cameras.

4. The system of claim 1, wherein said image data represents a two-dimensional image.

5. The system of claim 1, wherein said point reconstruction processor comprises logic for computing trigonometric constraints for matching conjugate points in the images of said cameras.

6. A multimodal point location method comprising the steps of:
acquiring at least two images of different modalities of a target object from corresponding cameras of different modalities; and
matching point coordinates in each of said two different images to reconstruct a point in a three-dimensional reconstructed view of said target object.

7. The method of claim 6, wherein said images are two-dimensional images.

8. The method of claim 6, wherein said matching step comprises the steps of: computing a rotation matrix and a translation vector for said images; and further computing conical constraints for said images.

9. The method of claim 6, wherein said matching step comprises the steps of: computing a rotation matrix and a translation vector for said images; and further computing trigonometric constraints for said images.

10. The method of claim 6, wherein at least one of said cameras is an optical camera.
